(19) United States
(12) Patent Application Publication
(10) Pub. No.: US 2008/0173160 A1
(43) Pub. Date: Jul. 24, 2008

(54) ELECTRIC GUITAR DESIGNED TO BE PLAYABLE BY AN INDIVIDUAL USING A PROSTHETIC DEVICE

(76) Inventor: Alexander Kokulis, Shrewsbury, MA (US)

Correspondence Address: CHOATE, HALL & STEWART LLP, TWO INTERNATIONAL PLACE, BOSTON, MA, 02110, US

(21) Appl. No.: 11/626,068

(22) Filed: Jan. 23, 2007

(51) Int. Cl. G10H 7/00

(52) U.S. Cl. 84/601

(57) ABSTRACT

An electric guitar designed to be playable by an individual using a prosthetic device comprises an electric guitar body and a plurality of sound-generating components disposed in the electric guitar body, the components sized and positioned to facilitate operation by a terminal device on an upper-extremity prosthesis.

### FIELD OF THE INVENTION

The present invention relates to systems for generating music. In particular, the present invention relates to a system for generating music by an electric guitar designed to be playable by an individual using a prosthetic device.

### BACKGROUND OF THE INVENTION

Electronic instruments have been an established feature in the music industry for some years and electric guitars, in particular, have become popular. The basic design of electric guitars typically corresponds to the design of traditional acoustic guitars. Conventional, upper-extremity prosthetic devices do not provide support for performing complex operations, such as picking one or more strings of a stringed instrument, or playing an instrument such as an electric guitar, which may require a musician to pick one or more strings on the guitar while also depressing one or more buttons. Nor are the components of typical stringed instruments designed to be playable by conventional prosthetic devices.

Specialized prosthetic devices, or customized attachments for prosthetic devices, may be designed to assist a musician with the use of a conventional electric guitar. However, such customizations may add to the cost of the prosthetic device, may require additional training, and may create additional challenges for individuals learning how to use prosthetic devices.

### BRIEF SUMMARY OF THE INVENTION

In one aspect, a system for generating music by an electric guitar designed to be playable by an individual using a prosthetic device comprises a means for generating sound disposed in an electric guitar body, the means sized and positioned to facilitate operation by a terminal device on an upper-extremity prosthesis. In one embodiment, the system further comprises a control assembly including the means for generating sound. In another embodiment, the means for generating sound further comprises a means for indicating pitch. In still another embodiment, the means for generating sound further comprises a means for indicating note activation. In yet another embodiment, the means for generating sound is sized and positioned to facilitate operation by a terminal device on an upper-extremity prosthesis without modification of the terminal device.

In one aspect, an electric guitar designed to be playable by an individual using a prosthetic device includes an electric guitar body and a plurality of sound generating components. The plurality of sound-generating components is disposed in the electric guitar body. The plurality of sound-generating components is sized and positioned to facilitate operation by a terminal device on an upper-extremity prosthesis.

In one embodiment, the electric guitar body further comprises a control assembly including the plurality of sound-generating components. In another embodiment, the plurality of sound-generating components comprises a plurality of fret keys. In still another embodiment, the plurality of sound-generating components comprises a plurality of strum keys. In yet another embodiment, the plurality of sound-generating components are sized and positioned to facilitate operation by a terminal device on an upper-extremity prosthesis without modification of the terminal device.

### BRIEF DESCRIPTION OF THE DRAWINGS

The foregoing and other objects, aspects, features, and advantages of the invention will become more apparent and better understood by referring to the following description taken in conjunction with the accompanying drawing, in which:

FIG. 1 is a diagram depicting one embodiment of an electric guitar playable by an individual using a prosthesis;

FIG. 2 is a diagram showing an electric guitar;

FIG. 3 is a section along 300-300 of FIG. 2; and

FIG. 4 is a section along 400-400 of FIG. 2.

### DETAILED DESCRIPTION OF THE INVENTION

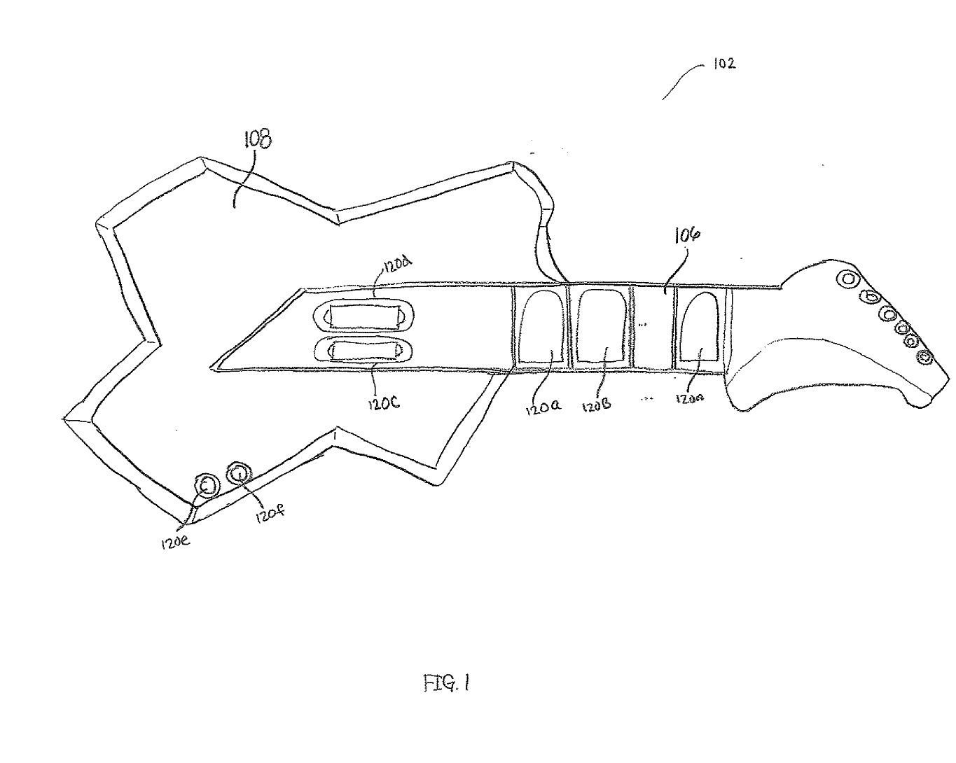

Referring now to FIG. 1, a diagram depicts one embodiment of an electric guitar. The electric guitar includes an electric guitar body 102 and a plurality of sound-generating components 120a-120n (generally referred to as a plurality of sound-generating components 120). The plurality of sound-generating components 120 is disposed in the electric guitar body 102 and positioned to facilitate operation by a terminal device on an upper-extremity prosthesis.

In some embodiments, the electric guitar 102 is battery-powered. In other embodiments, the electric guitar body 102 comprises a neck component 106 and a body component 108. In one of these embodiments, the neck component 106 is fixed to the body component 108. In another of these embodiments, a first subset of the plurality of sound-generating components 120 resides on the neck component 106. In still another of these embodiments, a second subset of the plurality of sound-generating components 120 reside on the body component 106.

In some embodiments, the electric guitar body 102 comprises a control assembly used to control the electric guitar 102. In one of these embodiments, the control assembly includes the plurality of sound-generating components 120. In other embodiments, selector switches and potentiometers are used to control the electric guitar 102. In still other embodiments, the electric guitar 102 includes a connection to an amplifier.

In one embodiment, the plurality of sound-generating components 120 is arranged at regular intervals along a longitudinal direction on the neck component 106 of electric guitar body 102. In another embodiment, the distance between each of the plurality of sound-generating components 120 is selected to facilitate manipulation of each of the plurality of sound-generating component 120 by an individual using a prosthetic device.

In some embodiments, the plurality of sound-generating components 120 includes a plurality of fret keys. In one of these embodiments, the plurality of fret keys may be arranged in parallel. In another of these embodiments, the plurality of fret keys is positioned on the neck component 106 to facilitate operation by an individual using a prosthetic device. In other embodiments, the plurality of sound-generating components 120 includes a plurality of strum keys. In one of these embodiments, the plurality of strum keys is positioned on the body component 108 to facilitate operation by an individual using a prosthetic device. In still other embodiments, the plurality of sound-generating components 120 includes a plurality of knobs. In one of these embodiments, the plurality of knobs include at least one volume knob. In yet other embodiments, the plurality of sound-generating components 120 includes a plurality of strum keys, a plurality of fret keys, and a plurality of volume knobs.

In one embodiment, the plurality of sound-generating components 120 is sized and positioned on the electric guitar body 102 to facilitate operation by a terminal device on an upper-extremity prosthesis without modification of the terminal device. In another embodiment, a distance between a first sound-generating component 120a in the plurality of sound-generating components 120 and a second sound-generating component 120b in the plurality of sound-generating components 120 is selected to make the plurality of sound-generating components 120 accessible to a terminal device on an upper-extremity prosthesis.

In some embodiments, the plurality of sound-generating components is provided as a plurality of buttons. In other embodiments, the plurality of sound-generating components is provided as a plurality of keys. In one embodiment, the plurality of sound-generating components is provided as a plurality of buttons, which are individually forced outward by springs and which sink inward by a specified amount when depressed. In another embodiment, mechanical push-button switches, such as microswitches, are provided on the back of the plurality of buttons.

In one embodiment, an individual using a prosthetic device presses one of the plurality of sound-generating components 120 to generate a musical tone. In some embodiments, the electric guitar body 102 includes a means for detecting that a user has pressed one of the plurality of sound-generating components 120. In one of these embodiments, a switch in the neck component 106 or the body 108 detects the pressing of one of the plurality of sound-generating components. In other embodiments, the electric guitar body 102 includes a means for outputting a signal indicating that a user depressed one of the plurality of sound-generating components. In one of these embodiments, the means for outputting the signal identifies a pitch of a tone to be generated. In another of these embodiments, the means for outputting the signal transmits the signal to a tone generator.

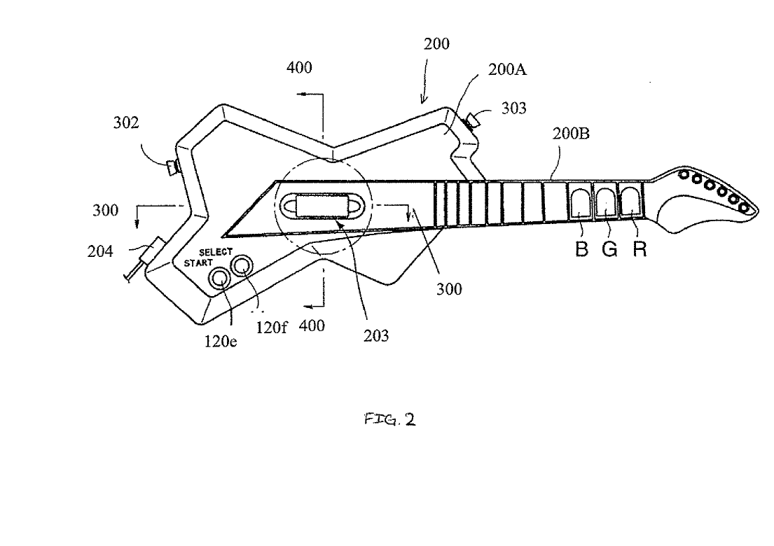

FIG. 2 is a perspective view showing the external configuration of one embodiment of a guitar 102. The simulated guitar 200 depicted in FIG. 2 includes a subset of the plurality sound-generating components 120—labeled, in FIG. 2, neck buttons R, G, B—providing rhythmic sound selecting means for selecting a kind of rhythmic sound for each sound along the flow of the music with time from a plurality of rhythmic sounds of the music, and a picking input means 203 as an output timing determining means for determining an output timing of a sound production instructing signal by selectively operating at least one of the neck buttons R, G, B, a select switch 102f provided below the picking input means 203 for switching additional modes including an echo mode for outputting substantially the same kind of sounds so as to echo and a chorus mode for substantially simultaneously outputting different kinds of sounds, and a start switch 102e for starting a music performance. The neck buttons R, G, B are an input means for left hand for guitar codes, and the picking input means 203 is an input means for right hand for inputting guitar picking. These input means for left and right hands may be reversed.

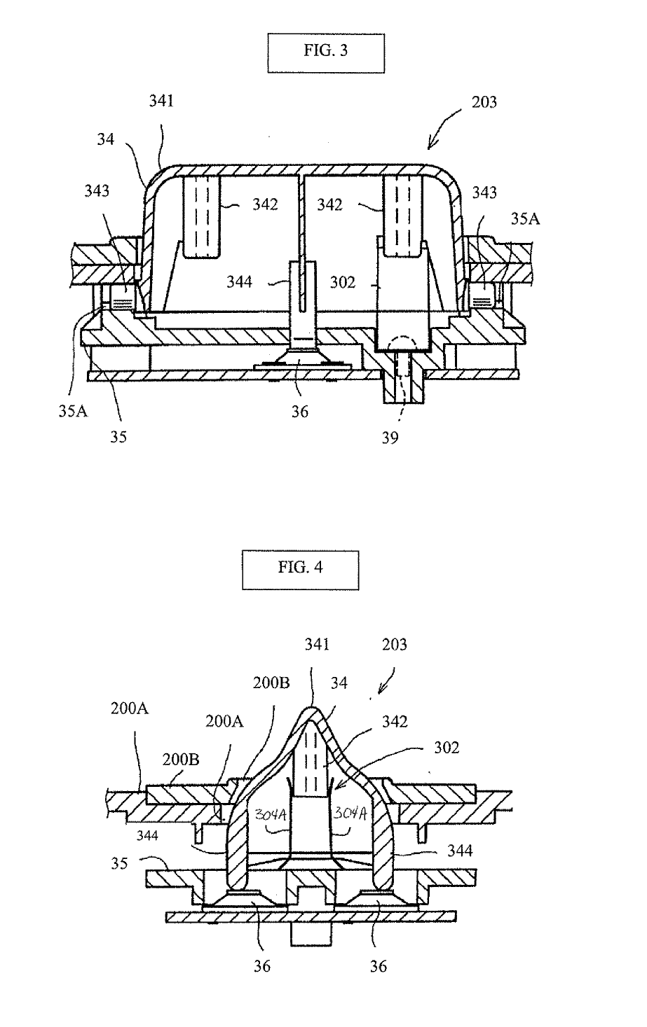

As shown in FIGS. 3 and 4, the picking input means 203 includes a picking blade 34, an elastically holding member 302 for rotatably supporting the picking blade 34, and rotation detecting means 36 provided at the opposite sides of a bottom portion of the picking blade 34 for detecting the rotation of the picking blade 34. In one embodiment, the guitar 200 is comprised of a main unit 200A; a neck unit 200B, provided with a plurality of sound-generating components 120, including the neck buttons R, G, B; and a rear side, which are so arranged that an opening 200A formed in the main unit 200A substantially coincides with an opening 200B formed in the neck unit 200B.

The picking blade 34 has a triangular cross section having an open bottom, and includes a top portion 341, two projections 342 having a fixed thickness and projecting downward from two positions on the inner surface of the top portion 341, two shaft portions 343 having a circular cross section and projecting outward from the opposite side surfaces of the picking blade 34, and two pushing portions 344 formed by thickening the walls of the picking blade 34 substantially at the longitudinal center of its inner surface from substantially the middle positions with respect to height direction to the bottom end. The respective pushing portions 344 act to push the rotation detecting means 36 located in a rotating direction by the rotation of the picking blade 34.

The shaft portions 343 are rotatably supported on recess-shaped shaft bearings 35a provided in mount members 35 coupled to the main unit 200A via screws 39 to be described later. In this supported state, the top portion 341 projects out through the openings 200A, 200B.

One of the two projections 342 having a fixed thickness is supported by the substantially U-shaped elastically holding member 302 which is mounted on the mount member 35 via the screw 539. The two projections 342 are symmetrically arranged with respect to the longitudinal direction of the picking blade 34.

The elastically holding member 302 is formed of a spring member and has two holding portions 304a, between which the projection 342 is inserted. Thus, when the picking blade 34 is picked to rotate, the projection 342 having a fixed thickness is inclined to thereby widen a spacing between the two holding portions 304a and, conversely, the two holding portions 304a try to narrow the spacing. This causes the picking blade 34 to return to its original reference position.

In the picking input means 203 thus constructed, when the picking blade 34 is picked in one of the rotating directions, the pushing portion 344 at the side of this rotating direction pushes the corresponding rotation detecting means 36. The rotation detecting means 36 outputs a sound production instructing signal representing a sound production instructing timing upon the lapse of a predetermined time after being pushed. Such a time lag is designed to make the guitar playing more realistic by approximating sound production to the one obtained when guitar strings would be actually picked. When the aforementioned picking is performed, the projection 342 having a fixed thickness is inclined to widen the spacing between the two holding portions 200a, and the two holding portions 200a conversely try to narrow the spacing. Accordingly, the picking blade 34 is returned to its reference position. The above applies to a case where the picking blade 34 is rotated in the other rotating direction although the other rotation detecting means 36 is involved here.

The neck buttons R, G, B provided on the front surface of the neck unit 200B are so constructed as to be pressable while being biased to project outward. A mechanical switch or the like for detecting that the button has been pressed is provided inside each of the neck buttons R, G, B. Thus, the operation of the corresponding neck button by pressing can be detected.

In some embodiments, the electric guitar 102 includes a central processing unit. In one of these embodiments, a means for outputting the signal transmits a signal to the central processing unit. In another of these embodiments, a means for determining that a button has been pressed transmits a signal to the central processing unit. In other embodiments, the electric guitar 102 includes a tone generator. In one of these embodiments, a central processing unit in the electric guitar 102 receives a signal identifying a tone to be generated and a pitch of the tone and the central processing unit sends a tone generation instruction signal to the tone generator.

What is claimed is:

1. An electric guitar designed to be playable by an individual using a prosthetic device, the electric guitar comprising:
an electric guitar body; and
a plurality of sound-generating components disposed in the electric guitar body, the components sized and positioned to facilitate operation by a terminal device on an upper-extremity prosthesis.

2. The electric guitar of claim 1, wherein the electric guitar body further comprises a control assembly including the plurality of sound-generating components.

3. The electric guitar of claim 1, wherein the plurality of sound-generating components further comprises a plurality of keys.

4. The electric guitar of claim 1, wherein the plurality of sound-generating components further comprises a plurality of fret keys.

5. The electric guitar of claim 1, wherein the plurality of sound-generating components further comprises a plurality of strum keys.

6. The electric guitar of claim 1, wherein the plurality of sound-generating components further comprises a plurality of knobs.

7. The electric guitar of claim 1, wherein the plurality of sound-generating components further comprises a plurality of volume knobs.

8. The electric guitar of claim 1 further comprising a plurality of sound-generating components disposed in the electric guitar body, the components sized and positioned to facilitate operation by a terminal device on an upper-extremity prosthesis without modification of the terminal device.

9. The electric guitar of claim 1, wherein the plurality of sound-generating components further comprises a distance between a first sound-generating component in the plurality of sound-generating components and a second sound-generating component in the plurality of sound-generating components, the distance selected to make the plurality of components accessible to a terminal device on an upper-extremity prosthesis.

10. The electric guitar of claim 1 further comprising a connection to an amplifier.

11. A system for generating music by an electric guitar designed to be playable by an individual using a prosthetic device comprising:
a means for generating sound disposed in an electric guitar body, the means sized and positioned to facilitate operation by a terminal device on an upper-extremity prosthesis.

12. The system of claim 11 further comprising a control assembly including the means for generating sound.

13. The system of claim 11, wherein the means for generating sound further comprises a means for indicating pitch.

14. The system of claim 11, wherein the means for generating sound further comprises a means for indicating note activation.

15. The system of claim 11, wherein the means for generating sound is sized and positioned to facilitate operation by a terminal device on an upper-extremity prosthesis without modification of the terminal device.

16. The means of claim 11 further comprising a means for connecting the electric guitar body to an amplifier.
